(19) United States
(12) Patent Application Publication
(10) Pub. No.: US 2010/0291261 A1
(43) Pub. Date: Nov. 18, 2010

(54) CONTINUOUS BREWING PROCESS

(75) Inventors: Peter Deuter, Freising (DE); Peter Gattermeyer, Freising (DE); Markus Lubbe, Ast (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KRONES AG, Neutraubling (DE)

(21) Appl. No.: 12/739,998

(22) PCT Filed: Oct. 31, 2008
(86) PCT No.: PCT/EP2008/009227

§ 371 Date: Jul. 9, 2010

(30) Foreign Application Priority Data
Nov. 2, 2007 (DE) 10 2007 052 471.6

(51) Int. Cl. C12C 7/06; C12C 7/165; C12C 7/20

(52) U.S. Cl. 426/16; 99/278

(57) ABSTRACT

A method for continuously producing wort as well as a method for carrying out said method, wherein order to optimize process times and avoid energy peaks, at least one of the processes for producing wort is continuously carried out at a substantially constant output.

### CROSS-REFERENCE TO RELATED APPLICATION

The present application claims the benefit of priority of International Patent Application No. PCT/EP2008/009227, filed Oct. 31, 2008, which application claims priority of German Application No. 10 2007 052 471.6, filed Nov. 2, 2007. The entire text of the priority application is incorporated herein by reference in its entirety.

### FIELD OF THE DISCLOSURE

The disclosure relates to a method for continuously producing wort as well as a device for carrying out said method, such as used in beverage brewing operations.

### BACKGROUND

Until now, the brewhouse process has taken place using the so-called “batch method”. Roughly up to 14 brews a day can be obtained. This method generates high energy peaks and consequently requires the provision of large supply capacities. Due to setup times between the individual production stages, the result is an only limited degree of efficiency for the systems. Altogether, batch operation leads to high investment costs for the systems, and also for the building services.

A quasi-continuous process can be realized by connecting in parallel a plurality of brew lines, which are then brought together into one continuous wort flow after the preparation of the wort. This solution involves increased control expenditures and a susceptibility to disturbances, however. Delays in one line continue in another. The investment costs for a plurality of parallel brew lines are also substantial.

Regarding the general state of the art and the fundamentals of the brewhouse process, reference is made in particular to “Technologie Brauer and Mälzer” (Technology for Brewers and Maltsters), 8^{th} edition, 1998, VLB Berlin, Chapter 3, page 187 to page 336.

### SUMMARY OF THE DISCLOSURE

With regard to this state of the art, one aspect of the disclosure is to provide a method and a device for producing wort that are simple to realize and that provide the optimized process times, whereby the general disadvantages listed above can furthermore be reduced or even avoided.

According to the disclosure, at least one of the individual processes for producing wort is continuously carried out. By “continuously” it is meant that, unlike in the state of the art, there is no interruption in the method after the treatment of a batch. According to the disclosure, for a long period of time that exceeds the duration of a corresponding, conventional process in batch operation by a multiple value, a certain mass flow is continuously added and simultaneously removed in the individual process steps. The process steps are consequently carried out with a substantially constant output, in the sense of process quantity per time. Power, such as heat and cooling capacities, are accordingly also continuously supplied, without any power peaks being necessary. In particular, during the mashing, heating of the lauter wort and boiling of the wort, heat carriers with a low energy level are possible. The system capacity can furthermore be reduced. Because the setup times between the batches are eliminated, there results better utilization of the systems and consequently a higher degree of efficiency. Due to the reduction in the energy level, there also results, in particular, a gentler method, which in turn results in higher wort quality. Because of reduced losses, it is simultaneously possible to save energy. The design of the system peripherals (heat, cold, air and water supplies) altogether is reduced, which in turn leads to savings in the investment costs.

In the mashing process, the mash is conducted through at least one pipe and at the same time is thermally treated and stirred in at least one area of the at least one pipe, and substantially laminarly conveyed in at least one other area for rest. To form the substantially laminar flow here, the mash can, for example, be drawn through the corresponding area by a plunger. The stirring, for example, by a stirring mechanism, allows heat to be introduced uniformly. During the laminar conveyance, the temperature is substantially held constant or increased slightly. The progression or, where appropriate, repetition of the individual process steps (i.e., thermal treatment and stirring or rest/laminar conveyance) can thereby be selected according to the process.

According to a preferred embodiment, during the mashing process the mash is thermally treated and stirred in a first area in a first stage, substantially laminarly conveyed through a second area in a second stage for rest, and again thermally treated and stirred in a third area in a third stage.

All known methods of the mashing process can be carried out: e.g., decoction, infusion, the springmaisch method, mashing of raw grain, metering of enzymes or other auxiliary materials as well as the addition of last runnings.

In order to allow a uniform introduction of thermal energy at a low flow speed during continuous mashing, the mash is stirred by a stirring mechanism in the first area. In the second stage, there is a rest in the second area during which the mash is not stirred, but is instead substantially laminarly conveyed through the pipe. Here the temperature of the mash is substantially maintained or increased only slightly. Finally, in a third stage, further thermal treatment and stirring takes place in a third area. The various stages here can take place in different sections of a heated pipe or instead in a plurality of interconnected pipes. Such a mashing process has extremely low emission due to the construction of the mashing device.

Because the process time is the same for all mash particles, a homogenous mash quality can be guaranteed. Due to the fact that the mash is heated up in heated pipes (whereby heating is arranged around the circumference of the pipe, i.e., in or at the pipe), there results a substantially greater heating surface/mash volume ratio than is the case with conventional mash tuns. As a result of the large heating surface and the relatively small volumetric flow rate, it is possible to do without very hot heating media, such as, for example, saturated steam, during the mashing, unlike in the state of the art. The at least one pipe can consequently be heated with a heating medium whose temperature is ≦120° C. and preferably between 80 and 100° C. Consequently, for example, hot water from solar energy, hot brewing liquor from the wort cooler or even waste heat from the individual process steps during the production of the wort could be used for heating the pipes.

Preferably, heat gained from the spent grains that arise during the lautering process is also returned to the process, for example, for heating the mash in the mashing process.

Even the energy from the hot spent grains, which has not been used in the past, can consequently also be exploited.

In the lautering process according to the disclosure, a preferred embodiment calls for the mash to be continuously conveyed from an upper area into a lower area in a lauter tower and horizontally lautered through a substantially cylindrical filter surface. A continuous process is possible due to the horizontal lautering and the vertical conveyance of the mash. The spent grains, for example, could then be discharged at the lower end of the lauter tower.

A plurality of soaking zones separated from one another are advantageously provided across the height of the lauter tower, whereby the lautered wort from the soaking zones is returned to the lauter tower at a level of at least one soaking zone, depending on a measured lauter wort condition, or is instead conducted into a first runnings tank in the direction of the wort boiling. Wort can consequently be returned from the soaking zones, for example, via a hollow shaft, until such a time as there is a clear wort flow. It is furthermore possible, for example, to return wort from a soaking zone with a very low extract content, i.e., consequently last runnings, to the lauter tower for sparging (i.e., washing out the spent grains). A last runnings tank can consequently be eliminated. All other process residues that arise can also be added to the lauter tower (for example, trub).

The lauter wort condition can be determined, for example, by measuring the turbidity and/or extract content.

Alternatively to this method, the mash to be lautered can also be continuously conducted into a plurality of mini lauter tuns, connected in parallel or in a row, each of which represents a soaking zone.

The mini lauter tuns here can be connected in parallel. The mash to be lautered can be fed either to one mini lauter tun after another, or simultaneously. The mini lauter tuns can also be combined into groups, whereby the various process steps of the lautering process are run through in the various groups.

The mini lauter tuns preferably exhibit a holding capacity of approximately 20 to 400 l. The reduction of the construction size of a lautering unit can produce a continuous process given a corresponding number of devices. The mash deposited in the mini lauter tun can be pressed in the direction of a filter membrane by a plunger. The lautered wort that is taken away from a mini lauter tun can be returned to at least one of the mini lauter tuns, depending on a measured lauter wort condition. This means that, for example, wort that is taken away from a mini lauter tun and that displays a very low level of wort extract can be used either as second wort or sparge liquor of the same or another mini lauter tun. A last runnings tank can consequently be eliminated. All other process residues that arise can also be added to the mini lauter tun (for example, trub).

A downstream underback can then collect the clarified wort and feed it to the wort boiling. Due to the fact that the plunger presses the mash in the direction of the filter membrane, the plunger at the end of the lautering can press the spent grain cake so firmly that this can then be removed from the mini lauter tun with a low moisture content. Wort can additionally be gained in this process and fed to the lautering process.

Alternatively to these lautering processes, the lautering process can also take place via a revolving belt filter.

For continuous boiling of the wort, the wort can advantageously be continuously conducted over heating surfaces of a wort boiling tower, the heating surfaces being arranged one above the other in the manner of a cascade. Due to the large heating surfaces that arise from this, the heating temperature can, in turn, be lowered. Because the wort runs through the tower from the top down, it is guaranteed that each particle of the wort is subjected to the same (in terms of both time and quantity) thermal necessities of a boiling process. In particular, a gentler method also consequently results, which in turn produces higher wort quality.

The mashing device according to the disclosure comprises at least one heatable pipe, whereby one area of the at least one heatable pipe has a stirring mechanism unit and another area has a conveyor device for laminar conveyance of the mash. Depending on the process, it is also possible for a plurality of heated areas to be provided with a stirring mechanism unit and/or for a plurality of areas to be provided with a conveyer device for laminar conveyance.

According to a preferred embodiment, the mashing device according to the disclosure comprises at least one heatable pipe, through which the mash is conducted and that has a first area, for thermal treatment of the mash, in which a stirring mechanism is arranged, as well as a second area for rest, in which the mash is conveyed substantially laminarly by means of a conveyer device, and a third area in which the mash is thermally treated and that likewise comprises a stirring mechanism. Such a device can be manufactured simply and economically. The conveyor device for the substantially laminar conveyance of the mash through the second pipe area can, for example, be realized by means of a scraper system or at least one maneuverable plunger. The scraper system or the maneuverable plunger are then, for example, arranged in such a way that the individual mash particles in the mashing device always exhibit the same holding time. The heating device is advantageously arranged around the circumference of the heated pipe (in or at the pipe). As discussed previously, due to the large heating surfaces, considerable advantages result particularly with regard to the necessary temperature level of the heating medium, e.g., the pipe diameter particularly in the first and third area lies between 80 and 150 cm. Such dimensions allow a relatively slow flow rate of the mash to be treated, so that a good introduction of energy is possible with homogenous mash.

The device according to the disclosure for lautering is formed as a lauter tower with a means of conveyance that conveys the mash to be lautered from the top down, as well as a substantially cylindrical filter surface, which is arranged around the means of conveyance, and an outer frame that encloses the filter surface. This allows the mash to be horizontally lautered. The space between the filter surface and the outer frame is divided by partitions into a plurality of soaking zones distributed across the height of the lauter tower, whereby the wort is taken away from these soaking zones. Because the wort concentration reduces in the lauter tower from the top down, it is expedient to take away the wort in the soaking zones that are separated from one another separately. Depending on the lauter wort condition, the wort can then namely either be fed to a first runnings container or instead returned to the middle of the lauter tower, or instead, as already explained, used as second wort or for sparging.

The means of conveyance advantageously comprises a centrally arranged hollow shaft by means of which water or lautered wort to be returned or otherwise known and serviceable residual and auxiliary substances (trub, residual beer, enzymes) can be fed to the individual soaking zones. A coil is preferably arranged on the hollow shaft. The spent grains can be prevented from floating by means of the coil mounted on the hollow shaft. The coil here presses the spent grains downwards. This makes a precisely defined treatment possible in the different soaking zones. The coil is also advantageous because it presses the spent grains downwards. As a result of the movement of the coil, pressing at the lower area of the lauter tower is also made possible, whereby the moisture content of the spent grains then is less than the moisture content of the spent grains in a classical lauter tun. Water pressed off from the spent grains can then preferably be fed to the lautering process through the hollow shaft.

The lautering device can also comprise a plurality of mini lauter tuns, each of which corresponds to a soaking zone. The device furthermore has a filling device for continuously placing mash into the mini lauter tuns. A mini lauter tun furthermore has a housing, in the lower area of which is arranged a filter membrane, as well as a device that can press the mash towards the membrane. Such a device can be realized by a vertically moveable plunger, for example. Such a system is very simple.

20 to 200 mini lauter tuns are used in this case, for example.

The device for lautering can also be realized by a revolving belt filter.

The device for lautering can also comprise a revolving filler as a filling device.

The device for continuous boiling of the wort can be realized by means of heating surfaces arranged one above the other in the manner of a cascade. The wort here can run over the hot heating surfaces, be buffered in a collective device and land on the heating surface below via an overflow.

### BRIEF DESCRIPTION OF THE DRAWINGS

The present disclosure is explained in more detail in the following with reference to the following figures:

FIG. 1 schematically shows a flow route for a wort preparation method according to the present disclosure;

FIG. 2 schematically shows a cross-section through a pipe of the mashing device that is shown in FIG. 1 or FIG. 3-6;

FIG. 3 schematically shows a further embodiment of a mashing device according to the present disclosure wherein a plunger lies in a first position;

FIG. 4 schematically shows the embodiment shown in FIG. 3, wherein a plunger is positioned in a second position;

FIG. 5 shows a cross-section through a second pipe according to a preferred embodiment;

FIG. 6 shows a cross-section through a second pipe according to a further embodiment of the present disclosure;

FIG. 7 is a schematic depiction of a lauter tower according to the present disclosure;

FIG. 8 shows a further embodiment for a lautering device according to the present disclosure, said lautering device comprising a plurality of mini lauter tuns;

FIG. 9 shows a cut through a device for boiling the wort according to the present disclosure;

FIG. 10 shows the main process steps in wort production.

FIG. 10 shows the main process steps in wort production. First, in the steps S0 and S1, the raw material handling takes place, i.e., the malt and raw grain receipt and the malt and raw grain handling. The fundamental steps in the brewhouse process are the crushing S2, the mashing S3, the lautering S4, the wort boiling S5, the hot break separation S6 and the cooling of the wort S7.

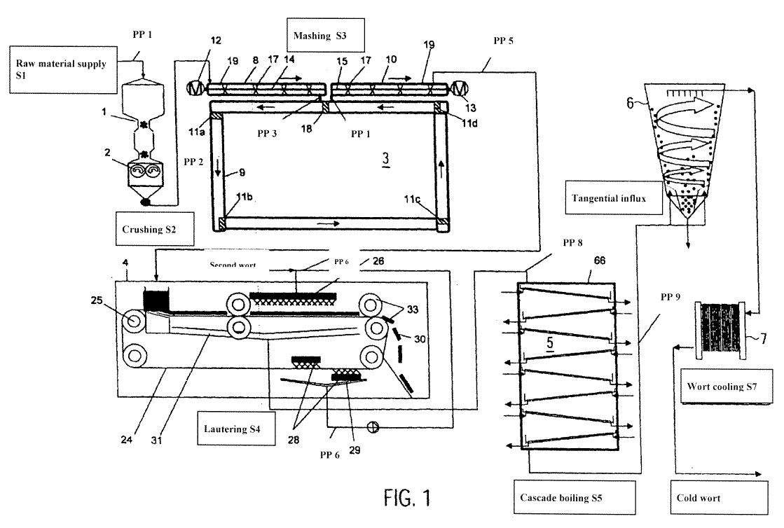

FIG. 1 shows a flow route for a continuous wort preparation process according to an embodiment of the present disclosure.

The method according to the disclosure does not take place in batch operation in accordance with the state of the art, but instead continuously, i.e., raw material is continuously fed in and at the end a continuous wort flow is produced.

The receipt and storage of raw materials, such as malt or raw grain, correspond to the method known from the state of the art and are subject only to the form of delivery and possibilities of the specific brewery. The continuous method does not influence this step S0.

The raw material handling (cleaning, dusting, weighing) S1 can be reduced by up to 25% of its capacity by means of continuous crushing.

As follows from FIG. 1, a malt mill 1 that continuously produces grist is provided for the crushing (S2). Due to the fact that the malt mill works continuously, its capacity can be reduced by up to 80%, which in turn eliminates energy peaks. In the mash producer 2 of the malt mill, water is added to the grist in order to produce mash. The mash is then fed to the mashing device 3 in a continuous flow. The mashing device 3 here is realized by the heated pipes 8, 9 and 10, through which the mash is continuously conducted.

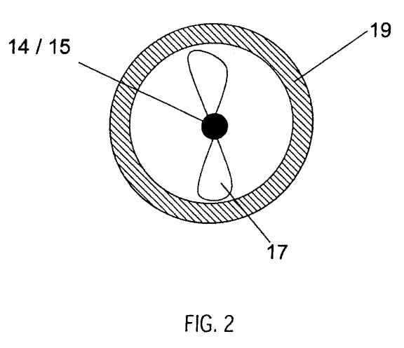

FIG. 2 shows a cross-section through the pipe 8 or 10. As can be seen in FIG. 2, the pipes have a heating device 19, e.g., a heat exchanger device, around their circumferences. In order to allow a uniform introduction of energy given the very low volumetric flow rate of roughly 2 m³/hr to 40 m³/hr, a stirring mechanism is installed along the heating pipes 8 and 10. The stirring mechanism in the pipe 8 comprises the shaft 14 driven by a motor 12, whereby this shaft 14 has a plurality of stirring devices, here stirring blades or paddles 17. The pipe 10 also comprises a stirring shaft 15 driven by a motor 13, the stirring shaft 15 having a plurality of paddles or blades 17. The mash is pressed into the mashing device 3, here the pipe 8, by the mash producer or instead by an additionally arranged conveyor device.

Between the first pipe area 8, in which the mash is thermally treated and stirred while being conveyed in the direction of the arrow, and the third pipe area 10, in which the mash is likewise thermally treated and stirred while being conveyed in the direction of the arrow, there is a second area 9, between PP 3 (process path 3) and PP 4, in which the mash is substantially laminarly conveyed. This area 9 serves for rest and to maintain or also to increase the temperature.

As shown in FIG. 1, the second pipe area 9 here has a scraper system that allows a uniform laminar flow of the mash. A plurality of scrapers 11a, b, c, d runs in the pipe 9 here. A scraper is, for example, a molded rubber part that is pressed by a driving medium, here the mash, through the pipe line 9. The scraper then conveys the mash farther in the direction of the arrow. When the mash enters the second pipe area 9 (PP 3) at the end of the first pipe area 8, the mash is driven in the direction of the arrow by the scrapers 11a, b, c, d. At the end of the second pipe area 9, there is a valve unit 18 for causing the product (PP 4) to branch. This means that the scraper 11 continues to run in the direction of the arrow, while the product, i.e., here the mash, is pushed into the third pipe area 10.

Here, in turn, the mash is pushed to the end of the mashing device 3 and, as in the pipe 8, is mixed by the parts of the stirring mechanism 15, 13, 17.

The diameters of the pipes 8, 9, 10 are roughly between 80 and 150 cm.

The mash leaves the third pipe 10 in a continuous flow (PP 5).

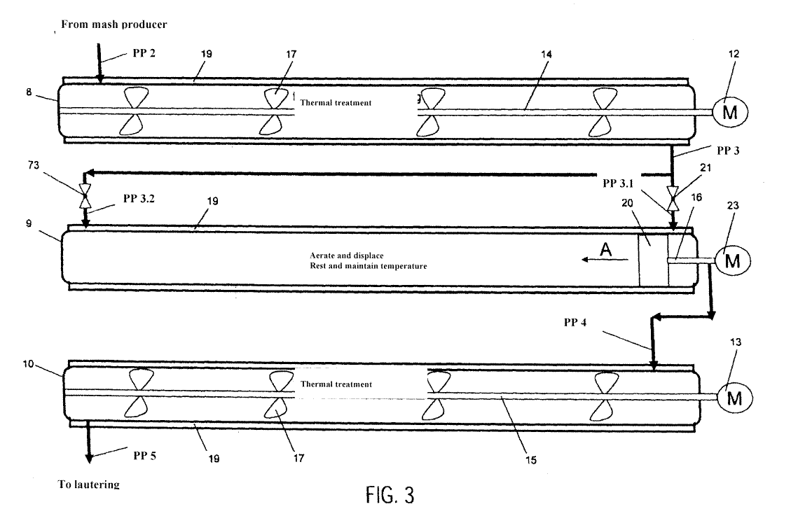

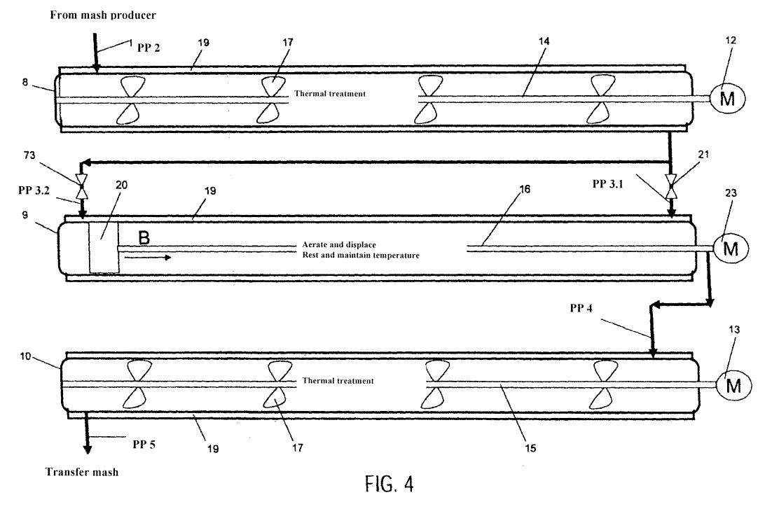

Instead of the pipe loop 9, which serves for rest and for laminar conveyance of the mash, an additional pipe 9 can also alternatively be provided, as is shown in FIGS. 3 and 4, which show a basic principle of this variant. The pipes 8 and 10 here correspond to the pipes 8 and 10 shown in FIG. 1. The mash is conducted from the end of the pipe 8 either to one end PP 3.1 or to the opposite end PP 3.2 of the pipe 9, depending on the switching state of the valves 21 and 73. The pipe 9 is likewise heated by means of a heater 19 and has, e.g., a motor 23 and a shaft 16, preferably a hollow shaft 16, and a movable plunger 20, preferably a hollow plunger 20, that alternates its movement between the direction of the arrow A (FIG. 3) or the direction of the arrow B (FIG. 4).

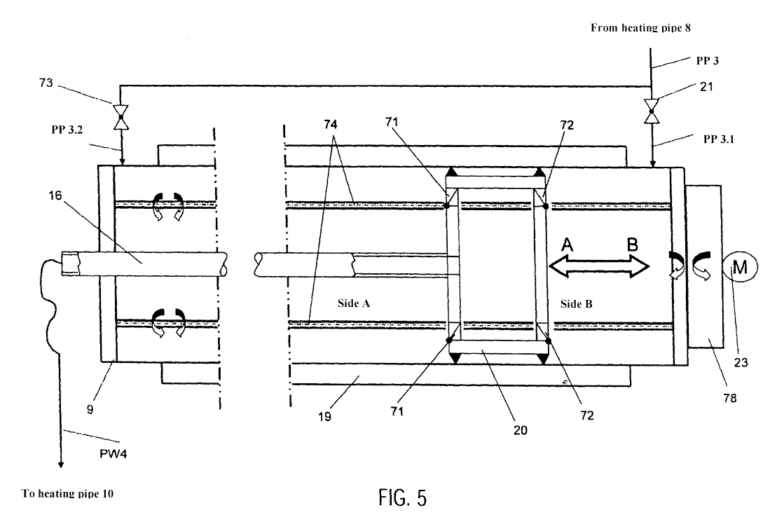

FIG. 5, for example, describes a preferred embodiment of the plunger 20 with the shaft system 16 beginning with FIG. 3, in the direction of movement A (valve 21 open, valve 73 closed), positive pressure develops on side A that presses the mash via the check valves 71 of the hollow plunger 20 (check valves 72 closed at the same time because of positive pressure) into the chamber of the hollow plunger and hollow shaft 16 to the next pipe 10, PP 4. The simultaneously arising negative pressure with this movement on the back side B of the plunger 20 draws in the mash of the pipe 8 via the open valve 21, process path PP 3.1, until the end position of the plunger 20, FIG. 4, is reached.

Due to a backward movement of the plunger 20 in the direction of the arrow B FIG. 4, the mash is then pressed out of the pipe 9 with the check valve 72 open (CVs 71 closed because of positive pressure) into the chamber of the hollow plunger 20 and the hollow shaft 16 to the next pipe 10, PP 4. Valve 73, process path PP 3.2 is open here, valve 21, process path PP 3.1 is closed. The plunger 20 moves in a defined manner in the direction of the arrows A and B by means of a frequency-regulated motor 23, the left-right running gearbox 78 and the non-rising threaded rods 74. In this variant, it is ensured that each mash particle is subjected to a uniform holding time and consequently a uniform mash treatment.

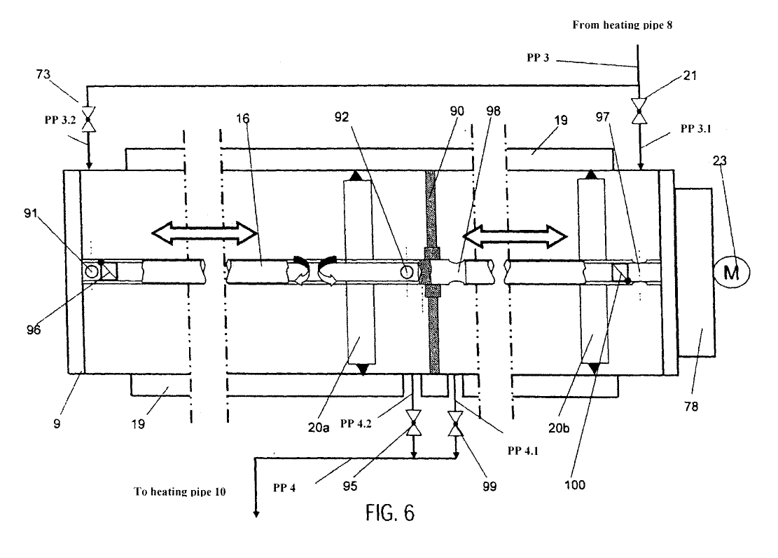

FIG. 6 shows a variation of the device shown in FIGS. 3, 4 and 5, whereby the plungers 20a and 20b and the hollow shafts 16 here are again formed in such a way that each mash particle has the same holding time in the second pipe.

In the variant shown in FIG. 6, mash is pulled from the heating pipe 8 via the path PP 3 with the valve 73 open, PP 3.2 and valve 21 closed with a plunger movement of the two plungers 20a and 20b from left to right into the left chamber of the left half of the heating pipe 9, whereby the distance between plungers 20a and 20b is always the same. If the plunger 20a has reached the middle separating plate 90, the movement of the plungers 20a, b reverses, valve 73 closes and valve 21, PP 3.1, opens. With the movement of the plunger 20a to the left, the mash is forced via the bore hole 90 and the bore hole 92 of the hollow shaft 16 from the left chamber into the right chamber of the left half of the heating pipe 9. The simultaneously moving plunger 20b now allows mash to flow into the right chamber of the left side of the heating pipe via the path PP 3.1. If the plungers 20a, b have reached the left side, the plunger movement reverses again, at which time the valve 95 opens the path PP 4.2 and mash reaches the third heating pipe 10. Reverse flow from the bore hole 92 to bore hole 91 is prevented by a stop valve 96. The right side works accordingly via the corresponding bore holes 97, 98 and the path PP 4.1, as well as the valves 99 and 100.

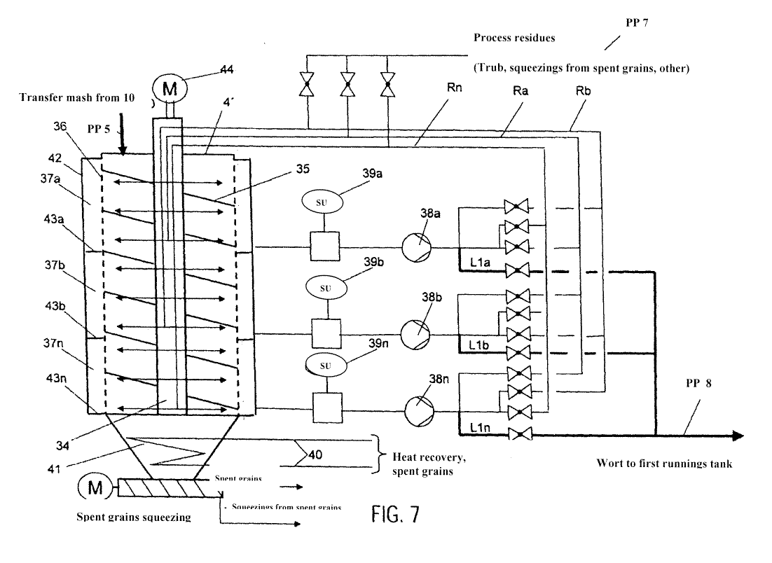

The length of the pipes 8, 9, 10 is roughly around 3 to 10 m, preferably around roughly 6 m. In the first pipe 8, the mash is mashed in all temperature ranges necessary for the process and heated up according to the necessities. Whereby the rest temperature is roughly 65° C. and the maximum temperature in the third pipe is roughly a maximum of 78° C., or can be up to 100° C. if enzymes are used. Various feed-ins of the heat carriers at various points allow selective temperature control. Because the mashing device functions continuously, setup times of roughly 6 hours/day are eliminated, which considerably optimizes the process performance. For example, if there are 1200 hl of bitter wort a day (this would correspond to a wort cast volume of roughly 100 hl in the batch method and 12 brews a day), the result would be a continuous mash treatment of roughly 3.5 m³/hr. With a daily production of 12,000 hl, this would correspond to a mash volume of roughly 35 m³/hr. In the case of the previously shown embodiment, with a standard length of 6 m and a diameter of 1 m, there results a possible heating surface of approximately 18 m²/pipe. With an assumed through-put time of 30 min. and, for example, the abovementioned volumetric flow rate of 3.5 m³/hr (0.002478 m/s), six times as much heating surface would be available for the mash volume as in a conventional batch container, or, with 3 heating pipes, 18 times as much. The heating rate can consequently be so moderately selected that the widest ranges of heating media or heat carriers are suitable. Consequently heating water from solar energy, hot brewing liquor from the wort cooler or waste heat from individual processes of the production of wort or beer can be used for heating the mash. Heating steam is not needed, as a rule. The temperature of the heating medium can amount to ≦120° C., preferably 80 to 100° C. It is most particularly advantageous if, for example, heat that is produced from the hot spent grains that arise during the lautering process and that have a temperature of approximately 75° C., for example via heat exchangers 40 (FIG. 7), is used for heating the mash in the mashing process. A further advantage of this arrangement is that it is free of emissions.

In the embodiments shown, it is also possible, e.g., to provide inlet and outlet lines for mash at certain points of the first pipe, in order to satisfy the various mashing methods (e.g., infusion or decoction method/addition of raw grain portions, other known mashing methods as well as additives).

By using enzymes, the mashing process can be accelerated considerably and the device for mashing can be simplified.

The disclosure was explained here with three pipe section 8, 9, 10. The concept according to the disclosure is not, however, limited to this configuration. The number and order of the different pipe areas can vary. What is essential, however, is that at least one area is provided for thermal treatment and mixing, and at least one area is provided for rest with laminar conveyance.

After the mashing process, the mash is continuously passed on to a device for lautering 4 (PP 5). In the case of the flow route shown in FIG. 1, a belt filter 4 is used as the device for lautering. The belt filter comprises a filter belt 24 revolving around rollers 25, for example a revolving plastic membrane, with a pore size of roughly 0.3 μm to 3 μm. The mash is brought onto the belt surface via a supply line (PP 5), whereby the wort that penetrates through the belt is caught, e.g. by a collecting tank 31. Second wort can be put on to the belt surface via a supply line (PP 6), for example, via the spray nozzles 26. The spent grains lying on the belt are compressed by the opposing rollers 33 and the compressed spent grains 30 are ejected at the end of the belt. For cleaning the belt, there are nozzles 28 on the lower side of the belt for the application of water so that residues of the spent grains can be washed out. This water can be caught via the collecting tank 29 and fed in via a line (PP 6) for any second wort. The belt filter allows continuous lautering without setup times between individual brews.

The lauter tower 4′ shown in FIG. 7 is suitable for continuous lautering as an alternative to the belt filter shown in FIG. 1. The lauter tower 4′ comprises a means of conveyance in the form of a hollow shaft 34 driven by a motor 44, whereby the hollow shaft 34 has a coil 35 arranged on it. The lauter tower furthermore has a substantially cylindrical filter surface 36 arranged around the means of conveyance 34, 35. The filter surface corresponds to the necessities of the grist composition, either to the false bottom of a conventional lauter tun, a membrane or a ceramic candle. The lauter tower furthermore has an outer frame 42 which encloses the filter surface 36 and seals it with respect to the outside. The lauter tower furthermore has partitions 43 that divide the space between the filter surface 36 and the outer frame 42 into a plurality of soaking zones 37a, b, n distributed across the height. In the lower area of the lauter tower, a conical section 41 that tapers downwards is provided. The lauter tower 4′ furthermore has a feed (PP 5) for transferring the mash, through which the mash is introduced into the lauter tower. The conveyor device, i.e., here, the coil 35 on the hollow shaft 34, conveys the spent grains from the top down in the direction towards the conical section 41. The wort concentration of the wort that here goes through the filter 36 decreases from the top down. This means that the wort that is removed from the various soaking zones 37a, b, n has a different wort concentration. Corresponding partitions for draining off the wort run out from the various soaking zones 37a, b, n that are distributed across the height of the lauter tower. Corresponding devices 39a, b, n are located in the wort partitions for determining the lauter wort condition, such as for example the turbidity and/or extract content. Furthermore, there is a lauter pump 38a, b, n in each of the corresponding lines in order to draw off the wort through the sieve surface/membrane 36 in the corresponding soaking zones 37a, b, n. Depending on the determined lauter wort condition, the wort can be fed via corresponding lines L1a, L1b, L1n either to a first runnings tank, which is not shown, whereby wort in various concentrations (depending on the respective soaking zone) is collected until a consistency is achieved, in order to be able to pass on a defined lauter wort in an appropriate concentration to the next brewhouse unit or fine clarification unit (membrane filtration).

Depending on the measured lauter wort conditions, however, the wort can also be conducted back into the hollow shaft 36 via corresponding return lines Ra, Rb, Rn. There is at least one opening in the hollow shaft 44 in each of the soaking zones. The line Ra, for example, guides the wort into the hollow shaft at the level of the first soaking zone 37a, the line Rb guides the returned wort into the hollow shaft at the level of the second soaking zone 37b, while the third (nth) line Rn guides the wort to be returned into the hollow shaft at the level of the nth soaking zone 37n. In this way, for example, wort with a low extract content can be fed into the hollow shaft again, for example as second wort or for sparging, to wash out the spent grains. The lauter tower furthermore has a possibility for feeding in liquid PP 7, e.g., for pH correction or the addition of trub, either through the hollow shaft or the upper side of the lauter tower. The lauter tower can, for example, have a height of 4 to 8 m and a diameter of roughly 0.8 to 1.5 m.

In order to fill the system the first time, the mash is, for example, first introduced from below via a feed that is not shown, until the system has been filled. Then the lautering can take place from the top. The coil 35 on the rotating shaft transports the mash from the top down. Wort is then pumped off through the spent grain cake and the filter surface 36 over the pumps 38a, b, n. The lauter wort conditions, such as turbidity and/or concentration, are measured with the help of the devices 39a, b, n. Wort is pumped from the soaking zones via the hollow shaft 34 until such a time as the desired quality of the wort flow is achieved. Then the wort is, as previously described, fed into the first runnings tank via the lines L1a, b, n and the collecting line (PP 8). As already mentioned, the wort can be fed to the lauter tower as last runnings via the return lines Ra, Rb, Rn, depending on the concentration, i.e., the extract content. The geometry of the tower allows a continuous mash flow from top to bottom. The spent grains can be prevented from floating by means of the coil 35 mounted on the hollow shaft. The coil here presses the spent grains downwards. The lixiviated spent grains are pressed down further by the coil of the hollow shaft 34. The rotating coil exerts a force on the spent grains in the direction of the bottom side of the lauter tower, as a result of which pressing is also achieved, whereby the moist percentage of the spent grains is lower than the moist percentage of the spent grains that arises in a classical lauter tun. The moist percentage can be further reduced by means of additional measures (pressing the spent grains). Water squeezed from the spent grains can preferably be fed to the lautering or mashing process. The pressed spent grains can then be output via a motor-driven unit for ejection of the spent grains.

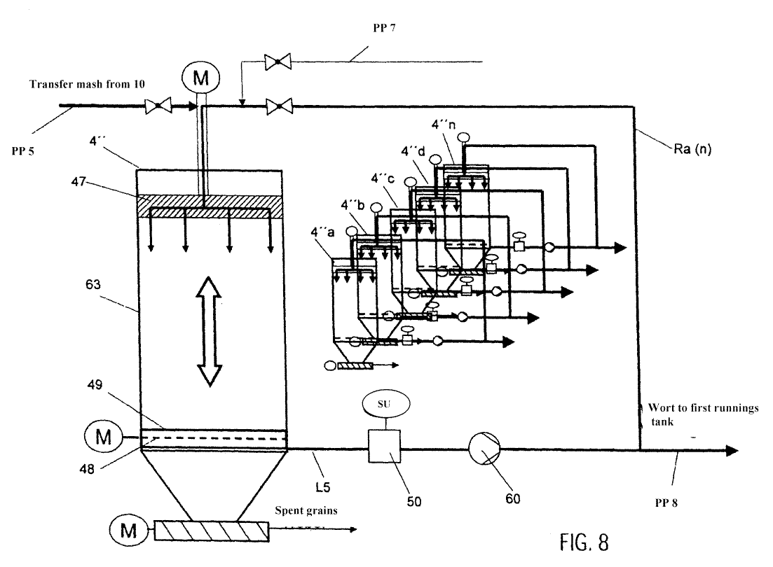

As shown in FIG. 8, the described system can, e.g., generate 100 to 300 hl of lauter wort per hour. For even higher output levels, preferably a plurality of units would have to be operated in parallel. The previously shown geometry of the lauter tower provides for a holding time of roughly 1.75 hours. The described tower allows a filter area of up to 40 m².

A further embodiment of the device for lautering according to the disclosure comprises a plurality of mini lauter tuns 4″a, b, n, connected in parallel and/or in a row, each of which represents a soaking zone. Mash to be lautered can be fed to the mini lauter tuns one after the other or simultaneously. The mini lauter tuns can also be combined into groups, whereby different lautering process steps, spaced apart from one another in time, run in different groups. A mini lauter tun comprises a housing 63. A filter membrane 48, according to the grist compositions, is arranged in the lower area.

The mini lauter tun furthermore comprises a vertically moving plunger 47, which can press the mash in the direction of the membrane 48 while also limiting the gas area to a minimum during filling. The filtrate is caught and, e.g., drawn off via the line L5. A device 50 is provided in the outlet line L5 for determining the lauter wort condition (such as extract content and/or turbidity, for example). A pump 60 for pumping off the wort is furthermore provided in the line. The lautered wort, which is conducted out of a mini lauter tun 4″a, . . . , n, can, depending on a measured lauter wort condition, be returned to at least one of the mini lauter tuns via the line Ra or fed to the first runnings tank PP 8. The mini lauter tun has a volume of 20 to 400 l. The mini lauter tun can be made of stainless steel, plastic or another suitable material.

Mash is deposited in the closed mini lauter tun by the plunger 47. The plunger moves here from its basic position at the membrane upwards without emissions as the filling increases until the mini lauter tun has been filled. If the mini lauter tun has been filled with mash, the lautering process can commence immediately. The mash deposits and forms a filter bed. The plunger can be located at the surface during the lautering, but could also be moved downwards depending on the process, until it has reached a certain distance to the membrane. As previously described, the wort is drawn out of the individual mini lauter tuns via the pumps 60. As already mentioned previously, the lauter wort condition is then measured and the lautered wort is either fed to the first runnings tank or to at least one mini lauter tun. A downstream underback collects the clarified wort, so that a desired concentration can be determined in order that the wort can then be fed to the wort boiling. The lautering process can be accelerated by means of hydraulic pressure. As a result of the pressure and the high spent grain cake, the lauter time can be reduced to less than 60 min. The plunger 47 can drive farther into the mini lauter tun at the end of the lautering process with a very great deal of pressure and press the spent grains. The pressed spent grains are removed from the mini lauter tun in that, for example, a unit 49, which comprises the membrane 48, drives out of the mini lauter tun and in this way shears off the pressed spent grains cake, which then in turn falls to the bottom of the mini lauter tun where it can be transported away.

For example, 20 to 200 mini lauter tuns can be arranged, e.g. in rows and in parallel. A cuboid with dimensions of 4×4×1.5 m would, for example, contain 100 mini lauter tuns. The system can be installed vertically or horizontally.

This device furthermore comprises a filling device (e.g., via the plunger 47), that introduces the mash into the lauter tuns. In order to allow a quasi-continuous process, the mash to be lautered is introduced continuously into the mini lauter tuns 4″a . . . n connected in parallel in a direction coming from the mashing device.

A combination of mini lauter tuns and a rotating filling technique is possible.

It is also possible to transport a plurality of mini lauter tuns one behind the other or in boxes of approximately 5 to 15 mini lauter tuns arranged next to one another horizontally for a certain path on a conveyor device in order to carry out the different lautering processes at different points along the path.

As follows from FIG. 1, the continuous wort boiling S5 takes place after the previously described lautering process by means of the corresponding devices for lautering. The lauter wort with preferably isomerized hops is then fed to the cascade boiler via a line PP 8.

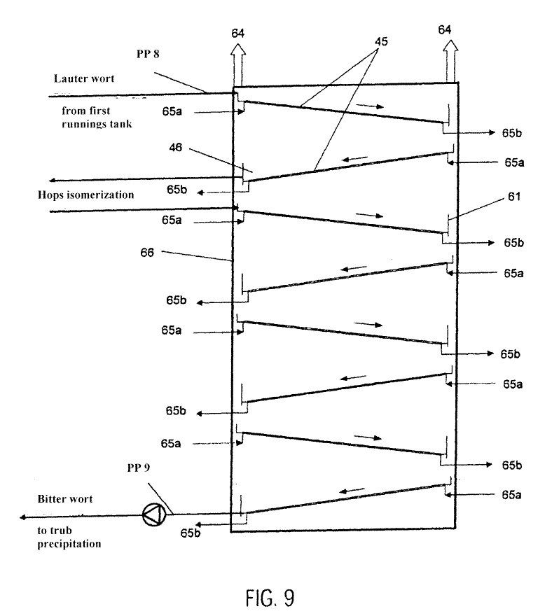

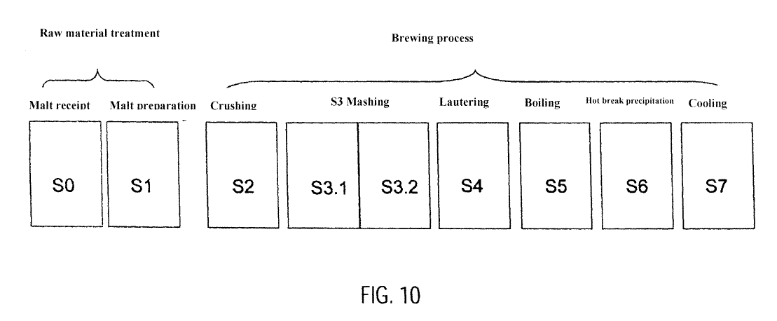

FIG. 9 shows a device for boiling wort that comprises substantially plate-like heating surfaces arranged diagonally one above the other in the manner of a cascade. The device has a feed (PP 8) for lauter wort (including isomerized hops), as well as an outlet (PP 9) for the boiled wort. The heating surfaces 45 are held in the device diagonally and have a buffer area 46 with an overflow 61 at the lower end. The heating surfaces are heated via a heat exchanger medium that is fed via a heating medium inlet 65a to the plate 45 and removed via a heating medium outlet 65b. In this embodiment, each separate heating surface 45 has a separate inlet and outlet for the heating medium. The device furthermore comprises a collecting line 64 for vapor.

When the wort is boiled, the wort runs into the device at the upper end via PP 8, runs over the heating surface 45 and collects in the buffer groove or the buffer area 46. At a certain height, the wort runs over the overflow 61 and lands on the heating surface below, and then runs down on this. When the wort runs down over the heating surfaces, the wort is heated to a sufficient degree to the necessary boiling temperature in order to achieve a defined evaporation. Because of the large heating surface, the heating temperature can be lowered from the temperature of conventional wort boiling, to 104 to 120° C. The wort continuously leaves the device for wort boiling 5 through the outlet (PP 9). Due to the fact that the device for wort boiling is continuously fed heat, power peaks such as found in conventional wort coppers can be avoided. In addition, the setup time is eliminated, so that the process time can be optimized. Emissions are freed only during the “first filling” and for “coming to a boil”, after which heat recovery can take place continuously through the vapor from the boiling.

The boiled wort is then fed to a device 6 (hot break precipitation), such as for example, a continuously working centrifuge or a continuously working sedimentation tank. Finally, the wort continuously produced by the device for hot break precipitation is fed to the wort cooler S7. The recovered heat of the wort to be cooled can also be used for direct heating of the mashing device S3.

### LIST OF ABBREVIATIONS

SO Malt receipt
S1 Malt processing
S2 Crushing
S3 Mashing
S4 Lautering
S5 Wort boiling
PP 1 Raw material preparation for mash production
PP 2 Mash for mash treatment S3
PP 3 Mash from pipe 8 to pipe 9
PP 3.1 Partitioned mash flow from PP 3
PP 3.2 Partitioned mash flow from PP 3
PP 4 Mash from pipe 9 to pipe 10
PP 4.1 Partitioned mash flow to PP 4
PP 4.2 Partitioned mash flow to PP 4
PP 5 Mash flow from pipe 10 to lautering
PP 6 Last runnings feed to band filtration
PP 7 Process residues, trub feed
PP 8 Lauter wort to boiling
PP 9 Hot wort to hot break separation
1 Malt mill
2 Mash production
4 Belt filter
4′ Lauter tower
4″ Mini lauter tun
8 Heating pipe
9 Resting pipe
11 Heating pipe
12 Scraper system (plunger a, ... d)
13 Motor, heating pipe 8
14 Motor, heating pipe 10
15 Shaft, heating pipe 8
16 Shaft, heating pipe 10
17 Shaft, resting pipe 9
18 Paddle, stirring mechanism
19 Valve for scraper control
20 Heating jacket, pipes 8; 9; 10
21 Plunger (a; b)
22 Valve
23 Motor, pipe 9
24 Belt of the belt filter
25 Deflection rollers, belt filter
26 Spray nozzles, belt filter
28 Cleaning unit, filter belt
29 Collecting tank, spray water, doses
30 Spent grains residue ejection—belt filter
31 Collecting tank, lauter wort—belt filter
33 Roller press—belt filter
34 Hollow shaft, lauter tower
35 Coil, lauter tower
36 Filter area, lauter tower
37 Soaking zones a to n—lauter tower
38 Lauter pumps a to n—lauter tower
39 Measuring devices a to n—lauter tower
40 Heat recovery—spent grains
41 Spent grains collecting tank—lauter tower
42 Outer wall—lauter tower
43 Soaking zone delimitation—lauter tower
44 Motor, hollow shaft—lauter tower
45 Heating plates—cascade boiling
46 Buffer—cascade boiling
47 Plunger—mini lauter tun
48 Membrane—mini lauter tun
49 Discharge, spent grains—mini lauter tun
50 Measuring device a to n—mini lauter tun
60 Lauter pump a to n—mini lauter tun
61 Overflow—cascade boiling
63 Housing of mini lauter tun
64 Vapor outlet—cascade boiling
65 Heating medium inlet/outlet—cascade boiling
66 Housing of cascade boiling
71 Check valves of plunger 20, pipe 9
72 Check valves of plunger 20, pipe 9
73 Valve
74 Spindles
78 Gearbox
90 Separating panel
91 Bore hole, hollow shaft 16
92 Bore hole, hollow shaft 16
95 Valve
96 Check valve, hollow shaft
97 Bore hole, hollow shaft 16
98 Bore hole, hollow shaft 16
99 Valve
100 Check valve, hollow shaft
L1 Lautering line (a to n)—lauter tower
L5 Lautering line (a to n)—mini lauter tun
R Return lines (a to n)

1. Method for continuously producing wort with a mashing process (S3), a lautering process (S4), a wort boiling process (S5) and a process for hot break separation (S6), wherein at least one of these processes is continuously carried out.

2. Method according to claim 1, and in the mashing process, conducting the mash through at least one pipe and at the same time thermally treated and stirred in at least one area of the at least one pipe and substantially laminarly conducted for rest in at least one other area.

3. Method according to claim 2, and drawing the mash into the area in order to form a substantially laminar flow.

4. Method according to claim 2, and during the mashing process thermally treating and stirring the mash in a first area in a first stage, substantially laminarly conveyed through a second area for resting in a second stage and, in a third stage, again thermally treated and stirred in a third area.

5. Method according to claim 1, wherein the process time for all mash particles is substantially the same.

6. Method according to claim 1, and during the mashing process heating at least one heated pipe, through which the mash is conducted, with a heating medium whose temperature is ≦120° C.

7. Method according to claim 1, and using the thermal energy that is produced from the waste heat of individual process steps for heating the mash in the mashing process.

8. Method according to claim 1, during the lautering process (S4) continuously conveying the mash in a lauter tower from an upper area to a lower area and horizontally lautering the mash through a substantially cylindrical filter surface.

9. Method according to claim 8, and a plurality of soaking zones separated from one another are provided distributed across the height of the lauter tower, wherein the wort lautered out of the soaking zones is returned to the lauter tower to at least one of the different soaking zones or is conducted into a first runnings tank, depending on a measured lauter wort condition.

10. Method according to claim 1, and during the lautering process continuously conducting the mash to be lautered into a plurality of mini lauter tuns.

11. Method according to claim 10, and pressing the mash deposited in the mini lauter tun in the direction of a filter membrane by a plunger.

12. Method according to claim 10, and returning the lautered wort that is removed from a mini lauter tun to at least one of the mini lauter tuns or is conducted into a first runnings tank, depending on a measured lauter wort condition.

13. Method according to claim 1, wherein the lautering process takes place by means of a revolving belt filter.

14. Method according to claim 1, and continuously conducting the wort over heating surfaces arranged one above the other in the manner of a cascade for the wort boiling.

15. Device for carrying out the method according to claim 1, comprising at least a mashing device, a lautering device, a device for wort boiling, well as a device for hot break separation, wherein at least one device is formed in such a way that the device works continuously.

16. Device according to claim 15, wherein the mashing device comprises at least one heatable pipe, wherein an area of the at least one heated pipe has a stirring mechanism unit and another area has a conveyor device for laminar conveyance of the mash.

17. Device according to claim 16, wherein the mashing device has a first area for thermal treatment of the mash, in which area a stirring mechanism unit is arranged, a second area for rest, in which area the mash is substantially laminarly conveyed by a conveyor device and a third area in which the mash is thermally treated and that comprises a stirring mechanism unit.

18. Device according to claim 16, wherein the conveyor device comprises a scraper system or at least one movable plunger.

19. Device according to claim 16, wherein the heated pipe comprises a heating device that is arranged around the circumference of the heated pipe.

20. Device according to claim 15, wherein the device for lautering comprises a lauter tower for the horizontal continuous lautering of the mash, which has a means of conveyance that conveys the mash to be lautered from top to bottom, a substantially cylindrical filter surface arranged around the means of conveyance and a outer frame that encloses the filter surface.

21. Device according to claim 20, wherein the space between the filter surface and the outer frame is divided by partitions into a plurality of soaking zones which are distributed across the height and from which the wort is removed.

22. Device according to claim 19, wherein the means of conveyance has a centrically arranged hollow shaft through which water or lautered wort to be returned can be fed to the individual soaking zones.

23. Device according to claim 22, wherein the means of conveyance comprises a coil arranged on the hollow shaft.

24. Device according to at least claim 13, wherein the device for lautering comprises a plurality of mini lauter tuns as well as a filling device for continuously introducing mash into the mini lauter tuns, wherein the mini lauter tuns have a housing, a filter membrane that is arranged in the lower area of the housing and a device that can press the mash in the direction of the membrane.

25. Device according to claim 24, wherein the device that presses the mash in the direction of the membrane is a vertically movable plunger.

26. Device according to claim 24, wherein a mini lauter tun has a holding capacity in a range of from 20-400 l.

27. Device according to claim 13, wherein the device for lautering is a revolving belt filter.

28. Device according to claim 15, wherein the device for wort boiling comprises heating surfaces arranged one above the other in the manner of a cascade.

29. Method according to claim 6, wherein the temperature of the heated medium is between 80° C. and 100° C.

30. Method according to claim 7, wherein the waste heat is from the hot spent grains that arise during the lautering process.

31. Device according to claim 20, wherein the outer frame is cylindrical.
